(19) United States
(12) Patent Application Publication
(10) Pub. No.: US 2017/0140077 A1
(43) Pub. Date: May 18, 2017

(54) METHOD FOR ASSESSING EFFICIENCY OF POWER GENERATION SYSTEMS

(71) Applicant: INSTITUTE FOR INFORMATION INDUSTRY, TAIPEI CITY (TW)

(72) Inventors: YU-HSIU LIN, NEW TAIPEI CITY (TW); YING-HSUN LAI, KAOHSIUNG CITY (TW); CHI-CHENG CHUANG, KAOHSIUNG CITY (TW)

(21) Appl. No.: 14/957,043

(22) Filed: Dec. 2, 2015

(30) Foreign Application Priority Data
Nov. 17, 2015 (TW) 104137860

(51) Int. Cl. G06F 17/50

(52) U.S. Cl. CPC G06F 17/5009

(57) ABSTRACT

The method for assessing efficiency in power production of a power generation system comprises: receiving meteorological data and environmental sensor data from potential power generation sites, wherein the meteorological data comprise weather-related factors, and the environmental sensor data comprise operation parameters of a power generation system; establishing a first-relationship model associated with the meteorological data from the potential power generation sites and weather-related factors from the assessed target site; receiving operation parameter of the power generation system at the potential power generation sites, and establishing a second-relationship model associated with the weather-related factor and the operation parameter; and receiving weather-related factors from the assessed target site, and estimating operation parameter of the power generation systems from the assessed target site according to the weather-related factor, the first-relationship model, and the second-relationship model.

### BACKGROUND OF THE INVENTION

1. Field of the Invention

The disclosure herein relates to a method for assessing efficiency of power generation systems. More particularly, the disclosure herein relates to a method for assessing efficiency in power production of a power generation system(s) in an assessed target site by leveraging meteorological data and localized environmental sensor data from the first nearest site that is the closest one in meteorological similarity rather than the similarity with geographical distance to the assessed target site.

2. Description of Related Art

A typical homeowner who is considering to use solar power must first find a list of solar providers and then arrange time to each of the solar providers to evaluate the potential of using solar power for the house. To the system and the method in this disclosure, an evaluation method for profiling a house's potential for using solar power through assessments of roof geometry and effects on shading from obstructions can be used as the first step to evaluate the house's potential of using solar power. The present application is a further application of U.S. patent application Ser. No. 11/740,087, filed Apr. 25, 2007, now U.S. Pat No. 7,500,391 entitled “System and Method for Identifying the Solar Potential of Rooftops.”

### SUMMARY OF THE INVENTION

This disclosure provides a method for predicting meteorological conditions to assess efficiency in power production of power generation systems with minimal sensor deployments under time-varying meteorological conditions. Power generation systems assessed by a computer system with the method provided by this disclosure can be solar photovoltaic systems in solar farms or other weather-dependent energy resources.

The method for assessing efficiency in power production of a power generation system comprises: receiving meteorological data and environmental sensor data from at least one of potential power generation sites to an assessed target site via the computer system, wherein the meteorological data comprise at least one weather-related factor, and the environmental sensor data comprise at least one operation condition as an operation parameter of the power generation system(s); establishing a first-relationship model associated with the meteorological data from the potential power generation sites and at least one weather-related factor from the assessed target site via the computer system; receiving at least one operation parameter of the power generation system of a power generation system of the potential power generation sites, and establishing a second-relationship model associated with the weather-related factor of the potential power generation site and at least one operation parameter of the power generation system of the computer system of the potential power generation site; and receiving at least one weather-related factor from the assessed target site via the computer system, and estimating at least one operation parameter of the power generation system from the assessed target site according to the weather-related factor, the first-relationship model, and the second-relationship model.

For further understanding of this disclosure, reference is made as the following detailed description illustrating the embodiments and embodiments of the disclosure. The description is only for illustrating the disclosure herein, not for limiting the scope of the claims.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic diagram of sites that are suitable for implementing the method for assessing efficiency in power production of a power generation system according to the weather-related factor with the operation condition as one of the operation parameters of a power generation system in one embodiment of this disclosure.

FIG. 2 illustrates the workflow of the method for assessing efficiency in power production of a power generation system(s) according to the weather-related factors with the operation parameter of the power generation systems in one embodiment of this disclosure.

FIGS. 3A, 3B, and 3C show the schematic diagrams of generating weather rules heuristically mined from the historical meteorological data and the historical operation data as the operation parameter of the power generation systems of a power generation system in one embodiment of this disclosure.

FIG. 4 illustrates a schematic diagram showing how the wind speed and the wind direction affecting the weather-related factor from the first nearest site in one embodiment of this disclosure.

FIG. 5 shows a schematic diagram of a weather relationship database of the weather-related factors and the operation parameter of the power generation systems in one embodiment of this disclosure.

FIG. 6 illustrates a schematic diagram showing the estimation of the operation parameter of the power generation systems of a power generation system according to the weather-related factors in one embodiment of this disclosure.

FIG. 7 shows the workflow of the method for assessing efficiency in power production of a power generation system, according to the estimated weather-related factors and the operation parameter of the power generation systems of the power generation system, in one embodiment of this disclosure.

### DETAILED DESCRIPTION OF PREFERRED EMBODIMENTS

The method provided by the disclosure herein is to estimate the weather factors affecting the efficiency of a power generation system, which are associated with the power generation conditions parameter of the power generation system. The method is mainly for the weather estimation of an assessed target site X where no localized environmental sensors are deployed. The localized environmental sensors can include irradiance sensors, anemometers, digital cameras (Charge Coupled Devices, CCD) for capturing images of sky over a geographic region of interest, and weather radars for determining the vertical structure of clouds and solar radiation influx reduction. In the method, weather of the assessed target site X is estimated according to the weather from the potential power generation sites, which further helps one assesses the efficiency of the power generation system. The power generation system can be a solar photovoltaic system(s) in solar farms. The power generation efficiency of a solar photovoltaic system is associated with the real-time weather. The time-varying weather-related factors affecting the efficiency of power generation can include: ultraviolet index (denoted as a variable “UV”), the irradiance (denoted as a variable “Irra”), the cloud coverage (denoted as a variable “Cover”), and other ones including atmospheric temperature, temperature in real feel, wind speed, wind direction, qualitative weather descriptions, and statistics of the weather factors above. The power generation system can also be a wind power plant, wherein the weather-related factors affecting the efficiency of power generation are mainly wind speed and wind direction.

Herein, the weather-related factor refers to the historical, real-time and future meteorological data from the assessed target site, and the historical, real-time and future meteorological data from the potential power generation site. The weather-related factors are, for example, UV index, atmospheric temperature, temperature in real feel, wind direction, wind speed, rainfall, pressure, cloud coverage and the like. In the method, the climate factors from the assessed target site and/or the potential power generation sites are also taken into consideration. The climate factors are represented by the historical meteorological data from the assessed target site and/or the potential power generation sites, which are obtained from the data collected in the past.

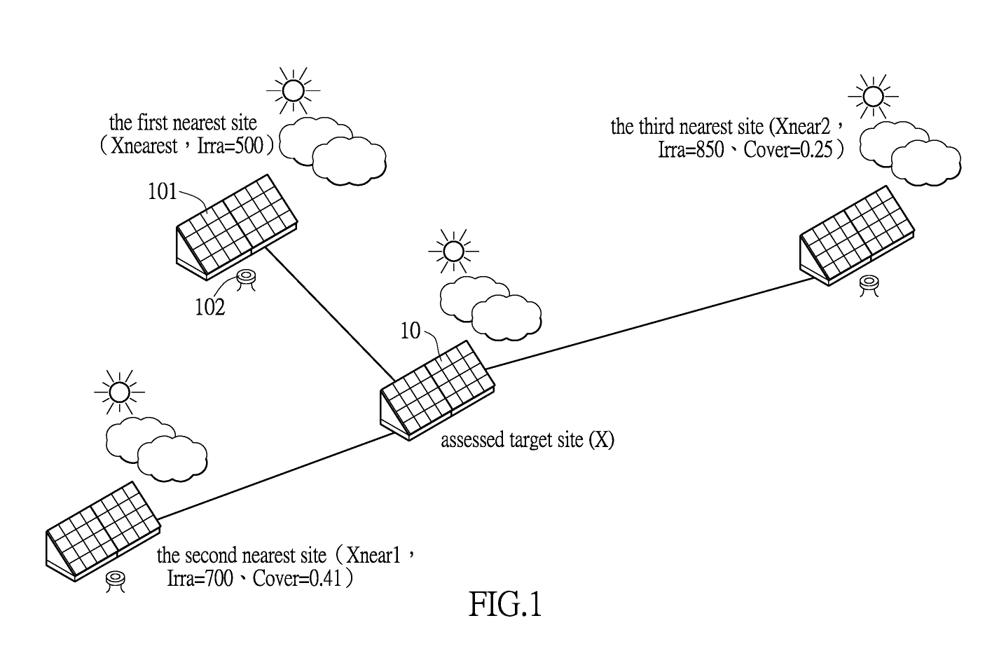

The method for assessing efficiency in power production of a power generation system provided by this disclosure is used in a system comprising many sites as shown in FIG. 1, wherein the power generation system is at the assessed target site. In FIG. 1, there is one assessed solar photovoltaic system comprising lots of solar panels 10. The assessed target site X has no localized environmental sensors deployed.

The meteorological patterns from the first nearest site Xnearest are close to the meteorological patterns from the assessed target site X. For example, the first nearest site Xnearest can be chosen according to the historical meteorological data. The historical meteorological data are, for example, maximum or the minimum UV index, average atmospheric temperature, average cloud coverage, rainfall and the like. There is also a power generation system built in the first nearest site Xnearest. The first nearest site Xnearest can be, for example, a potential power generation site that is geographically close to the assessed target site. Thus, the real-time meteorological data from the first nearest site Xnearest may directly or indirectly affect the weather of the assessed target site. Also, the first nearest site Xnearest can be a potential power generation site having meteorological patterns that are close to the meteorological patterns of the assessed particular power generation site but not close to the assessed particular power generation site in distance. The historical meteorological data and the historical operation parameter of the power generation system from the first nearest site Xnearest can be used to estimate how the efficiency of the power generation system would be affected by weather from the assessed particular power generation site. The historical meteorological data and the historical operation parameter of the power generation system can be obtained from the computer system and a weather relationship database from the first nearest site Xnearest.

The meteorological data from the first nearest site Xnearest can be references when estimating how the weather would affect the efficiency of the power generation system. The meteorological data can be, for example, the data obtained via the irradiance sensor 102 (a sensor metering atmospheric temperature, temperature in real feel, or one of the other ones), which result in the level of the assessment of the efficiency of the solar panel 101. Moreover, the historical meteorological data from the first nearest site Xnearest can be references when estimating weather of the assessed target site.

For example, the real-time meteorological data from the first nearest site Xnearest including irradiance, atmospheric temperature, working temperature of the solar panel, wind speed, wind direction, and cloud coverage may affect the estimation of weather and the operation parameter of the power generation systems of the power generation system in the assessed target site. As long as the relationship between weather of the assessed target site and weather of the first nearest site Xnearest is established, weather rules can be also established. Even though there are no localized environmental sensors deployed in the assessed target site, based on the weather rules the computer system deducing the meteorological data from the assessed target site can infer the operation parameter of the power generation systems.

There would be other potential power generation sites in which the meteorological patterns are close to the meteorological patterns of the assessed target site, such as the second nearest site denoted as Xnear1 (Irra=700, Cover=0.41) and the third nearest site denoted as Xnear2 (Irra=850, Cover=0.25). In addition to the computer system for data processing, there are different kinds of environmental sensors already-deployed in the second nearest site Xnear1 and the third nearest site Xnear2. Also, the historical meteorological data are acquired and stored in a cloud database linked with the computer systems via Internet. The distances and the geographical relationships among the assessed target site, the second nearest site Xnear1, and the third nearest site Xnear2 are different. With construction of the weather rules, different weight coefficients may be generated for different weather-related factors. For example, the equation for estimating the irradiance of the assessed target site based on the irradiance sensed of each of the three potential power generation sites can be represented as follows:

Irra=Wnearest*Irranearest+Wnear1*Irranear1+Wnear2*Irranear2

As shown in FIG. 1, Irra=0.5*500+0.35*700+0.15*850=622.5. The coefficients 0.5, 0.35, and 0.15 are the weight coefficients of the first nearest site Xnearest, the second nearest site Xnear1, and the third nearest site Xnear2, respectively. The weight coefficients are obtained according to weather and the geographical locations among the assessed target site, the first nearest site Xnearest, and the second and third nearest power generation sites Xnear1 and Xnear2.

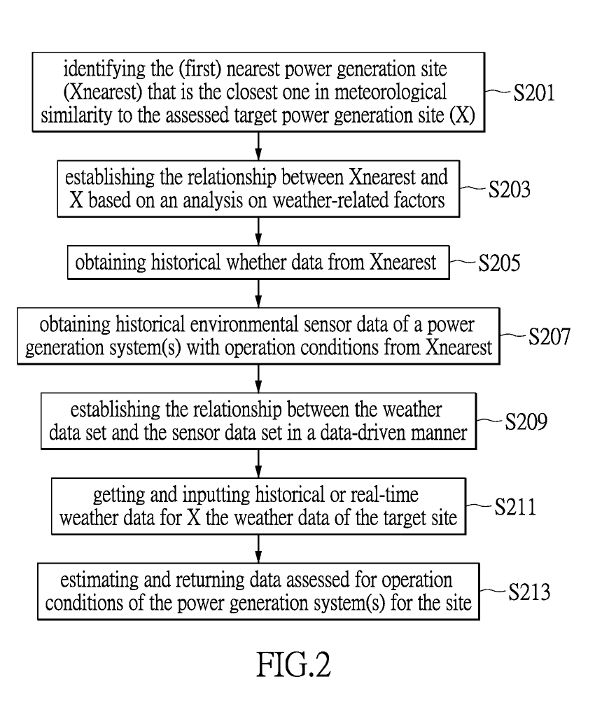

FIG. 2 shows the workflow of the method for assessing efficiency in power production of a power generation system according to the estimation of weather-related factors with operation parameter of the power generation systems in one embodiment of the disclosure herein.

Step S201: identifying the first nearest power generation site Xnearest that is the closest one in meteorological similarity to the assessed target power generation site X. Specifically speaking, through an analysis on the meteorological data, the first nearest site Xnearest that is the closest one in meteorological similarity to the assessed target power generation site X is identified. Besides, more sites that are close in meteorological similarity to the assessed target power generation site X are identified. For instance, the first nearest site Xnearest, the second nearest site Xnear 1, and the third nearest site Xnear 2 are identified and shown in FIG. 1.

Step S203: establishing the relationship between the first nearest site Xnearest and the assessed target power generation site X based on an analysis on weather-related factors with meteorological data. Specifically speaking, in Step S203, a first-relationship model is established, wherein the first-relationship model is associated with meteorological data from the first nearest site Xnearest (or one of the two power generation sites and weather-related factors with meteorological data from the assessed target site X.

In Steps S205, S207, and S209, in order to obtain or estimate meteorological data for the assessed target site, the computer system learns from changes of the weather-related factors of the potential power generation sites (including change of UV index, cloud coverage, wind speed, wind direction, and the other ones) to the estimation of the weather-related factors with meteorological data. The weather-related factors estimated for the assessed particular power generation site affect the estimation of the efficiency of the power generation system(s) in the assessed target site.

Step S205: obtaining historical whether data of the first nearest site Xnearest. Specifically speaking, the historical meteorological data gathered from the first nearest site Xnearest or the potential power generation sites are obtained. The historical meteorological data of the first nearest site Xnearest or the historical meteorological data of the potential power generation site are obtained by the computer system and from the weather relationship database of the first nearest site Xnearest, the second nearest site Xnear1 or the third nearest site Xnear2. If there are lots of potential power generation sites can be references, the meteorological pattern of each potential power generation site would be identified first. Then, based on the location of each potential power generation, different weight coefficients are used to estimate the weather-related factors affecting the efficiency of the power generation system at the assessed target site. The computer system of the assessed target site obtains the meteorological data and the environmental sensor data (such as irradiance, working temperature, wind strength, wind direction and the like) from the computer system(s) of the first nearest site Xnearest and/or other potential power generation sites.

In one embodiment, the computer system also obtains the historical meteorological data and the historical operation parameter of the power generation systems. The historical meteorological data comprise at least one qualitative weather description and the weather rules associated with the qualitative weather description and the weather-related factors. The computer system establishes a third-relationship model associated with the weather-related factors and the operation parameter of the power generation systems of the potential power generation site according to the weather rules, the historical meteorological data, and the historical operation parameter of the power generation systems.

Step S207: obtaining historical environmental sensor data from a power generation system(s) with operation conditions of the first nearest site) (nearest. Specifically speaking, the computer system of the assessed target site can obtain the historical operation parameter of the power generation systems from the weather relationship database of at least one potential power generation site, such as the first nearest site Xnearest, the second nearest site) Xnear 1, or the third nearest site Xnear2. For example, regarding a solar plant, working temperature of the solar panel can be obtained via a temperature sensor, and irradiance of each solar panel can be obtained via the irradiance sensor. After that, via the data analysis, the weather rules according to the relationship between the weather-related factor and the operation parameter of the power generation system can be inferred. Step S209: establishing the relationship between the meteorological data set and the sensor data set in a data-driven manner. Specifically speaking, in Step S209, a second-relationship model is established, which is associated with the weather-related factor of the potential power generation site (including the first nearest site Xnearest) and the operation parameter of the power generation system of the assessed target site. In other words, based on the weather rules with the real-time meteorological data of the assessed target site, the computer system deduces the weather-related factors for the assessment of the efficiency of power generation to the target site. In short, weather of the assessed target site can be estimated. The weather-related factor to the assessed target site for assessing the efficiency of the power generation system(s) deployed in it is computed and obtained by the computer system, according to the first-relationship model with the meteorological data of the potential power generation site.

Step S211: getting and inputting historical or real-time meteorological data from the assessed target site X. Specifically speaking, there are no localized environmental sensors deployed in the assessed target site, so the real-time meteorological data, the meteorological data as Open Data from the assessed target site need to be obtained from weather service providers. The weather service providers can include the National Weather Service, Weather Underground from local weather stations, or a commercial alternative one. The local weather stations have been deployed for specialized applications such as detecting UV for UV-related health effects to people and wind conditions. Step S213: according to the second-relationship model established in Step S209, the operation parameter of the power generation systems including irradiance and working temperature of the solar panels in the assessed target power generation site can be estimated. Based on the weather-related factors with meteorological data from the assessed target site, the first-relationship model, and the second-relationship model, the computer system estimates the operation parameter of the power generation systems, while it assesses the efficiency of the power generation system(s) in the assessed target site.

The above-mentioned weather-related factors as references for estimating the operation parameter of the power generation systems and assessing the efficiency of the power generation system(s) in the assessed target site include historical and real-time meteorological data obtained from Open Data resources with Big Data analytics. To a solar power generation system, irradiance, Irra, estimated by the method in this disclosure varies with clouds. Cloud coverage to a solar power generation site may change with effects associated with wind speed and wind direction.

Via a heuristic analysis on historical meteorological data gathered from Open Data with Big Data analytics, weather rules can be constructed. The weather rules help the computer system estimate the weather-related factor as the operation parameter of the power generation system and assess the efficiency of the power generation system(s) for the assessed target site.

Regarding a solar power generation system, the above-mentioned weather-related factors can include irradiance associated with cloud coverage. Irradiance by UV affects the power generation of the solar panels. Wind strength with wind direction also affects the power generation of the solar panels shaded by clouds moving over sky. Moreover, there are other ancillary factors, such as relative humidity, dew point and the like. Regarding a wind turbine generator system, wind speed and wind direction directly affect the efficiency of the wind turbine generator system. Via the above description of this disclosure, these weather-related factors can be all estimated according to the meteorological data from the potential power generation sites.

In one embodiment, one way to identify the first nearest site Xnearest is to determine based on the meteorological data from many potential power generation sites. The potential power generation site having the meteorological patterns most close to the meteorological patterns from the assessed target site would be chosen as the first nearest site Xnearest. For example, the plenty of weather-related factors of the potential power generation site are compared with the meteorological data from the assessed target site, which results in lots of differences. After that, the potential power generation site having the smallest difference can be chosen as the first nearest site Xnearest. Sometime, the potential power generation site geographically close to the assessed target site may not have meteorological patterns close to the meteorological patterns of the assessed target site.

The factors for identifying the first nearest site Xnearest can further include the geographical location and the latitude, based on which the first nearest site Xnearest can be also obtained.

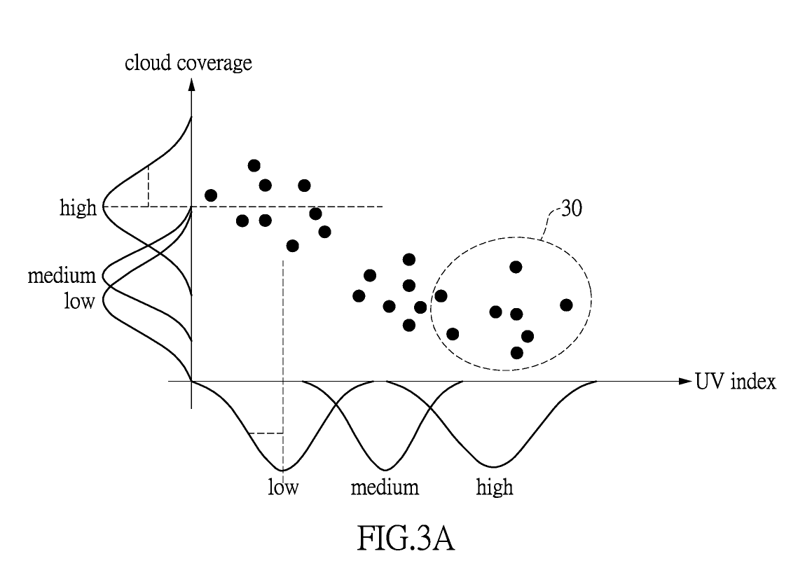

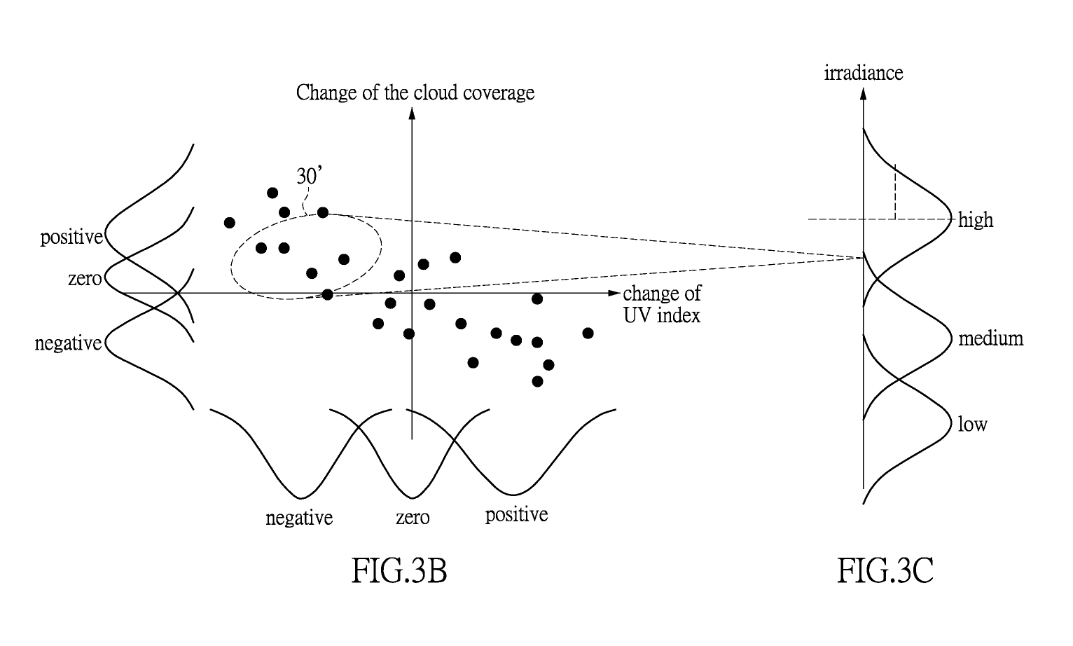

In the method for assessing the efficiency of the power generation system disclosed by this disclosure, the weather rules can be constructed based on the statistics of the historical meteorological data. The historical meteorological data include at least one qualitative weather description. According to the statistics of the weather-related factors, the meteorological patterns affecting the efficiency of the power generation system can be inferred based on the weather rules, please refer to FIGS. 3A, 3B and 3C.

As shown in FIG. 3A, each point represents for a data point sampled at certain timing. The coordinate graph shows the relationship between the cloud coverage (longitudinal axis, low, medium and high) and the UV index (lateral axis, low, medium and high) at each data point. The lateral axis can be further divided from UV=0 to UV=11+. Based on the coordinate graph and the data points, the weather rules can be generated. The weather-related factor shown by the above graph can also be the temperature, the temperature in real feel, wind speed, the wind strength and the like; however, it is not limited herein.

According to the statistics of the historical data, the longitudinal axis representing the cloud coverage is divided into segments showing the high coverage, medium coverage and low cloud coverage, and the lateral axis representing the UV index is also divided into segments showing the low, medium and high UV indexes. As shown in FIG. 3A, some of data points are within the variation range of data statistics 30 representing for the high cloud coverage and the low UV index, some of data points are within the area variation range of data statistics 30 representing for the medium low cloud coverage and the medium cloud coverage, and some of data points are within the variation range of data statistics 30 representing for the low cloud coverage and the high UV index.

The data points can be shown in the relation graph of the change rate of the cloud coverage (longitudinal axis; negative, zero and positive) and the change rate of the UV index (lateral axis; negative, zero and positive), as shown by FIG. 3B. Based on the data points shown in the variation range of data statistics 30 in FIG. 3A and the data points shown in the variation range of data statistics 30′ in FIG. 3B, the coordinate graph showing the irradiance (Irra; high, medium and low) can be obtained as shown in FIG. 3C. The obtained coordinate graph shown in FIG. 3C (based on FIG. 3A and FIG. 3B) generates the weather rules. Likewise, other data points in each variation range of data statistics correspond to certain weather rules.

The weather rule (represented as: “if . . . , and . . . ”) can be, for example:

The rule 1: if the UV index is high and the cloud coverage is low, the change rate of the UV index is positive and low and the change rate of the cloud coverage is negative and low, and the wind speed is low, which infers that the irradiance of the solar panel is high.

The rule 2: if the UV index is medium and the cloud coverage is low, the change rate of the UV index is positive and low and the change rate of the cloud coverage is negative and low, and the wind speed is low, which infers that the irradiance of the solar panel is medium.

The rule 3: if the UV index is high and the cloud coverage is low, the change rate of the UV index is negative and high, the change rate of the cloud coverage is positive and high, and the wind speed is high, which infers that the irradiance of the solar panel is medium.

In this embodiment, the computer system receives the historical meteorological data from the first nearest site Xnearest (including the qualitative weather description and the historical operation parameter of the power generation system), and generates the weather rules associated with the relationship between the qualitative weather description and the weather-related factor. Based on the weather rules and the historical meteorological data and the historical operation parameter of the power generation system, a third-relationship model associated with the relationship between the historical meteorological data and the historical operation parameter of the power generation system, is established. Thus, the relationship between each weather-related factor can result in certain weather rules, which can further establish a weather relationship database.

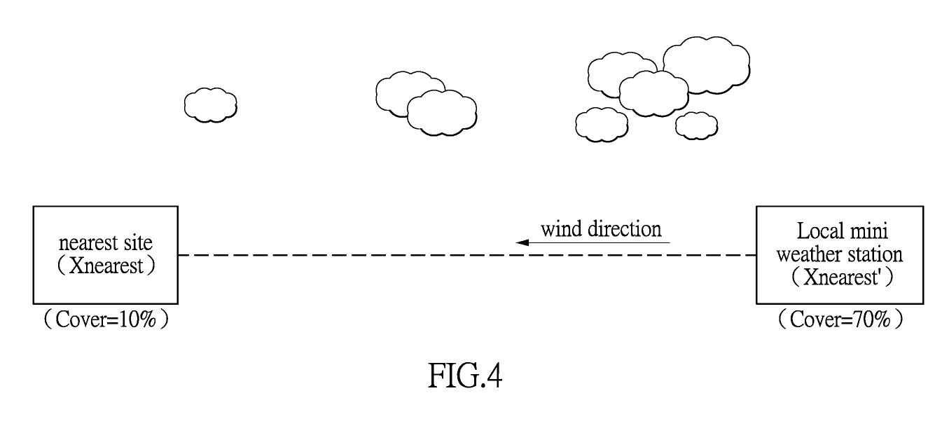

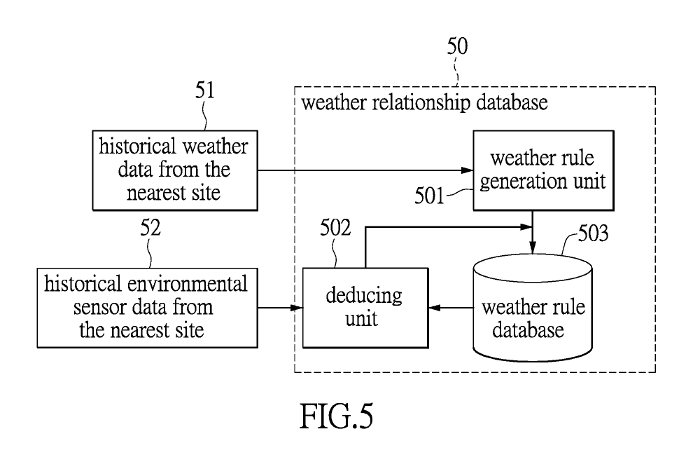

FIG. 4 shows a schematic diagram showing how wind speed and wind direction affect the weather-related factor from the first nearest site in one embodiment of this disclosure. The meteorological data from the assessed target site X are estimated according to the meteorological data from the first nearest site Xnearest. The estimation for the meteorological data from the assessed target site based on the meteorological data from the first nearest site Xnearest or other potential power generation sites would be affected by the real-time meteorological data obtained via the local mini weather station at the first nearest site Xnearest or other potential power generation sites.

As shown in FIG. 4, in the first nearest site Xnearest, the cloud coverage is 10%, and the cloud coverage sensed by the local mini weather station from the first nearest site Xnearest is 70%. The meteorological data obtained via the local mini weather station from the first nearest site Xnearest can be taken as the Open Data which are provided to the computer system from the first nearest site Xnearest, for example the local mini weather station is linked to the computer system via the Internet. In FIG. 4, clouds that are associated with wind going in incoming direction to the first nearest site move from right to left. Thus, it can be predicted based on the wind speed that the cloud coverage from the first nearest site Xnearest will increase, which further affects the estimation for the meteorological data from the assessed target site X and the estimation for the efficiency of the power generation system.

This above weather rules can be applied in this embodiment. The wind speed with the change of the cloud coverage (for example, the cloud coverage of the local mini weather station minus the cloud coverage from the first nearest site) can determine how the wind speed would affect the irradiance.

Regarding to the how the historical meteorological data of one potential power generation site affects the efficiencies of the power generation systems at the potential power generation site, the first nearest site and the assessed target site, this disclosure establishes a weather relationship database 50 associated with the weather-related factor and the operation parameter of the power generation system, to show the weather rules constructed based on the historical meteorological data and the historical operation parameter of the power generation system, please refer to FIG. 5. FIG. 5 shows a schematic diagram of a weather relationship database of the weather-related factor and the operation parameter of the power generation system in one embodiment of this disclosure.

As shown in FIG. 5, the weather relationship database 50 associated with the weather-related factor and the operation parameter of the power generation system receives the historical meteorological data 51 from the first nearest site Xnearest, then generates the weather rules via the weather rule generation unit 501, and then the weather rule weather rule database 503 is further established. The relationship weather relationship database 50 associated with the weather-related factor and the operation parameter of the power generation system also receives, from the rule learning and deducing unit 502, the historical operation data 52 of the power generation system from the first nearest site. Based on the weather rules, the historical meteorological data and the historical operation parameter of the power generation system, how the weather affects the efficiency of the power generation system can be assessed. For example, the UV index affecting the working efficiency of the solar panel is associated with the irradiance of the solar panel, the atmospheric temperature/ temperature in real feel is associated with the working temperature of the solar panel, the wind strength, the relative humidity and the like. The weather rule database 503 would be updated based on the calculation for the weather rules and the operation parameter of the power generation system.

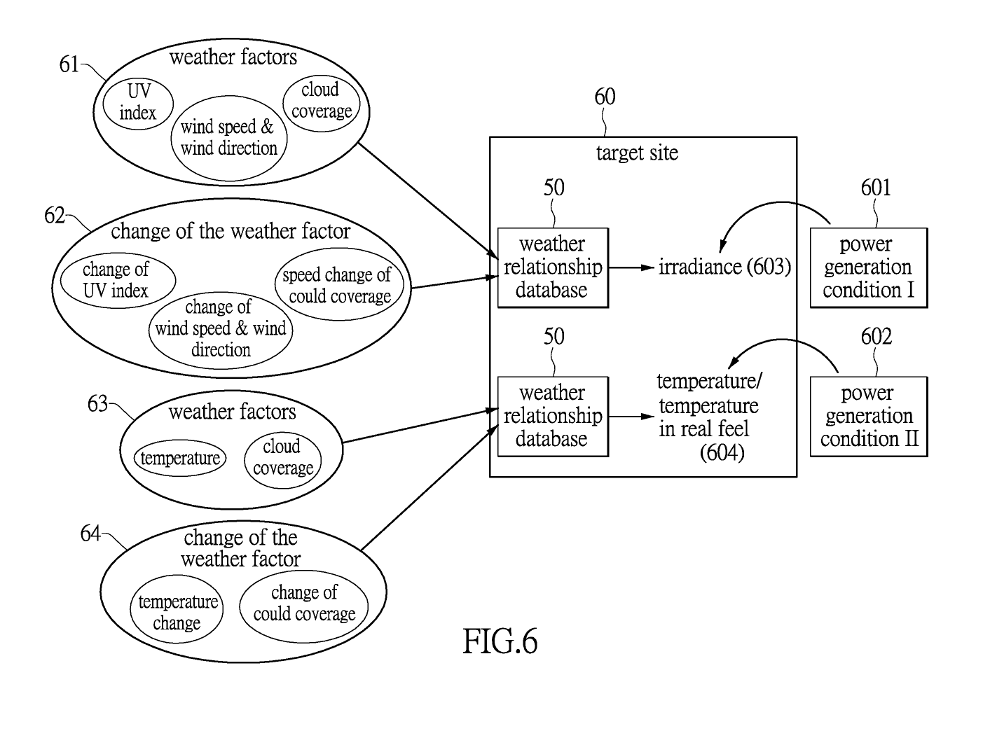

The weather relationship database 50 associated with the weather-related factor and the operation parameter of the power generation system can be used in the site having no environmental sensors deployed, such as the assessed target site. The application includes the estimation for the operation parameter of the power generation system of the power generation system according to the weather factors, and the prediction for the abnormal condition of the power generation system, please refer to FIG. 6.

As shown in FIG. 6, there is a computer system at an assessed target site 60. The information of one potential power generation site can be obtained via the weather relationship database 50 associated with the weather-related factor and the operation parameter of the power generation system, such as the weather-related factor 61 obtained from the weather relationship database 50 associated with the weather-related factor and the operation parameter of the power generation system. In this embodiment, the weather-related factors 61 include the UV index, the wind speed and wind direction, the cloud coverage and the change of weather 62. The change of weather 62 includes the change of the UV index, the change of the wind speed and the wind direction, and the change of the cloud coverage. The operation parameter of the power generation system is affected according to the weather-related factors 61 and the change of weather 62. In this embodiment, by knowing the weather-related factor of one potential power generation site and its change of the weather-related factor, a power generation condition I 601 of the site with the irradiance 603 can be obtained via the weather relationship database 50 of the weather-related factor and the operation parameter of the power generation system.

Another weather-related factor affecting the operation parameter of the power generation system can be the atmospheric temperature/temperature in real feel 604. The computer system from the assessed target site 60 receives the weather 63, such as the atmospheric temperature, the cloud coverage and the change of the weather-related factor 64, such as the change of the atmospheric temperature, the change of the cloud coverage and the like. How the weather 63 and the change of the weather-related factor 64 affect the operation parameter of the power generation system can be estimated according to the weather relationship database 50 associated with the weather-related factor and the operation parameter of the power generation system. For example, as the weather-related factor and the change of the weather-related factor of one potential power generation site are given, a power generation condition II 602 related to the working temperature of the solar pane with respect to the temperature/felt air temperature 604 from the assessed target site 60 can be obtained.

Considering the weather-related factor from the first nearest site Xnearest and its effects on the efficiency of the power generation system, the efficiency of the power generation system at the assessed target site 60 having no environmental sensors deployed, can be estimated via taking the weather relationship database 50 associated with the weather-related factor and the operation parameter of the power generation system as a virtual sensor from the assessed target site 60. Also, whether the operation of the power generation system is abnormal can be determined and even predicted. Moreover, the historical weather-related factor and the historical operation parameter of the power generation system can optimize the system parameters and the distribution of the power usage.

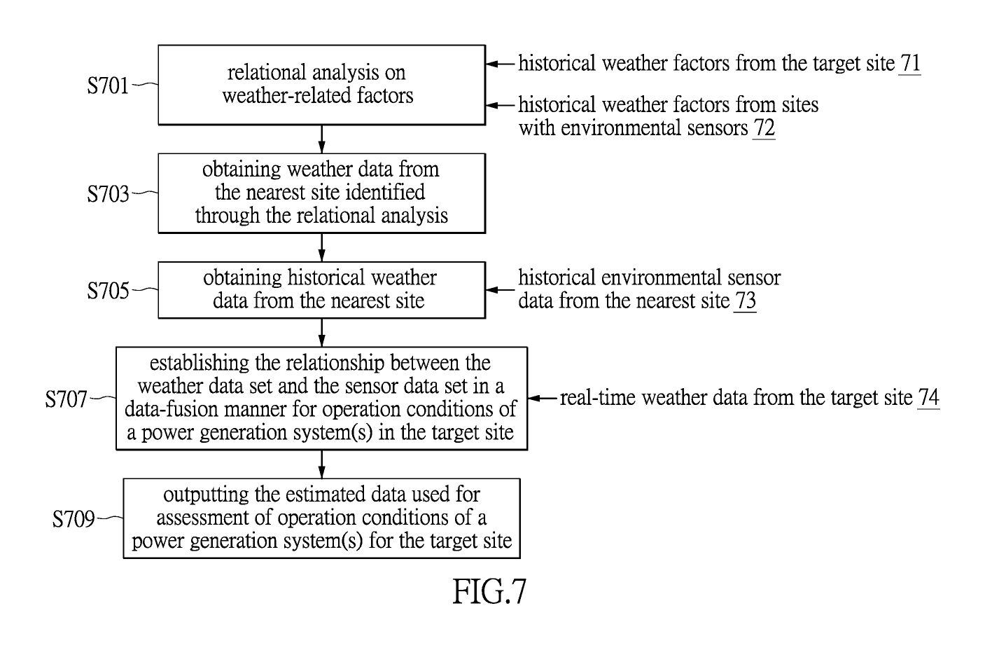

FIG. 7 shows the workflow of a method for assessing efficiency in power production of a power generation system, according to the estimated weather-related factor and the operation parameter of the power generation system of the power system, in one embodiment of this disclosure.

Step S701: having relational analysis on weather-related factors. Specifically speaking, in order to identify the first nearest site of which the meteorological patterns are close to the meteorological patterns from the assessed target site X. The computer system executes an analysis for the weather-related factors. The analyzed factors comprise: the historical weather-related factors 71 from the assessed target site X having no environmental sensor deployed, and the historical weather-related factors 72 from plenty of potential power generation sites Xnear with environmental sensors. Step S703: obtaining meteorological data from the nearest site identified through the relational analysis. Specifically speaking, the real-time and the historical meteorological data from the first nearest site Xnearest are obtained between time intervals. Step 705: obtaining historical meteorological data from the nearest site. Specifically speaking, the obtained real-time and the historical meteorological data from the first nearest site Xnearest include historical power generation condition data 73 from the first nearest site Xnearest. For example, the real-time and the historical meteorological data from the first nearest site Xnearest are obtained every five minutes.

Step S707: establishing the relationship between the meteorological data set and the sensor data set in a data-fusion manner for operation conditions of a power generation system in the assessed target site. Specifically speaking, the relationship between the meteorological data and the power generation condition data from the first nearest site Xnearest is established, and the relationship between the meteorological data from the first nearest site Xnearest and the power generation condition data from the assessed target site X is thus obtained. Thus, by knowing the real-time meteorological data 74 from the assessed target site X, such as the UV index, the cloud coverage, the atmospheric temperature/ temperature in real feel, the wind strength, the wind direction and the like. Step S709: outputting the estimated data used for assessment of operation conditions of a power generation system(s) for the assesses target site. Specifically speaking, the needed operation parameter of the power generation systems of the power generation system from the assessed target site X can be estimated in Step S709, such as the irradiance of the solar panel, the working temperature of the solar panel and the like. Also, whether the operation of the power generation system at the assessed target site is abnormal can be determined. In addition, whether it is proper to build a power generation system in the assessed target site can be determined by estimating the meteorological data from the assessed target site and based on the historical meteorological data, such as a newly built wind turbine generator system.

In the method for assessing the efficiency of the power generation system provided by this disclosure, by analyzing the weather-related factor of the potential power generation site and the operation parameter of the power generation system of the power generation system at the potential power generation site, the weather-related factor that affects the efficiency of the power generation system at the assessed target site can be estimated in real-time, so as to predict the efficiency of the power generation system and whether the operation of the power generation system from the assessed target site will be abnormal.

Accordingly, in the method for assessing the efficiency of the power generation system provided by this disclosure, for a assessed target site having no environmental sensors deployed, by analyzing the weather-related factor of one or more potential power generation sites and the operation parameter of the power generation system of the power generation system at one or more potential power generation sites, the weather-related factor that affects the efficiency of the power generation system at the assessed target site can be estimated in real-time. For example, the efficiency of the solar panel of the solar power generation plant can be assessed, which can increase the reliability of the power generation system, reduce the cost for building the environmental sensors and control the labor cost and the material cost for maintaining the system device.

The descriptions illustrated supra set forth simply the preferred embodiments of this disclosure; however, the characteristics of this disclosure are by no means restricted thereto. All changes, alterations, or modifications conveniently considered by those skilled in the art are deemed to be encompassed within the scope of this disclosure delineated by the following claims.

What is claimed is:

1. A method for assessing efficiency in power production of a power generation system, implemented via a computer system, comprising:
receiving meteorological data and environmental sensor data from at least one of potential power generation sites to an assessed target site via the computer system, wherein the meteorological data comprise at least one weather-related factor, and the environmental sensor data comprise at least one operation condition as an operation parameter of the power generation system;
establishing a first-relationship model associated with the meteorological data from the potential power generation sites and at least one weather-related factor from the assessed target site via the computer system;
receiving at least one operation parameter of a power generation system of the potential power generation sites, and establishing a second-relationship model associated with the weather-related factor of the potential power generation site and at least one operation parameter of the power generation system of the potential power generation site; and
receiving at least one weather-related factor from the assessed target site via the computer system, and estimating at least one operation parameter of the power generation system from the assessed target site according to the weather-related factor, the first-relationship model, and the second-relationship model.

2. The method according to claim 1, wherein the step of receiving meteorological data and environmental sensor data from at least one of potential power generation sites of an assessed target site via the computer system further comprises:
receiving recordings of historical meteorological data and a historical operation parameter of the power generation system of a first nearest site via the computer system, wherein the historical meteorological data comprise at least one qualitative weather description; and
storing weather rules associated with the qualitative weather descriptions and the weather-related factors, and establishing a third-relationship model associated with the weather-related factor and the operation parameter of the power generation system of the potential power generation site according to the weather rules, the recordings of the historical meteorological data and the historical operation parameter of the power generation systems.

3. The method according to claim 1, further comprising:
assessing the efficiency of a power system from the assessed target site via the computer system according to at least one operation parameter of the power generation system from the assessed target site.

4. The method according to claim 3, wherein the step of receiving a meteorological data and a operation parameter of the power generation system of at least one of potential power generation sites of an assessed target site via the computer system further comprises:
receiving recordings of historical meteorological data and a historical operation parameter of the power generation system from the first nearest site via the computer system, wherein the historical meteorological data comprise at least one qualitative weather description; and
storing weather rules associated with the qualitative weather descriptions and the weather-related factors via the computer system, and establishing a third-relationship model associated with the weather-related factor and the operation parameter of the power generation system of the potential power generation site according to the weather rules and recordings of the historical meteorological data, and the historical operation parameter of the power generation system.

5. The method according to claim 1, wherein the operation parameter of the power generation system comprises at least the strength of the ultraviolet radiation or the surface temperature of the solar panel.

6. The method according to claim 1, wherein the operation parameter of the power generation system comprises the wind strength associated with efficiency of a wind turbine generator system.

7. The method according to claim 1, wherein the potential power generation sites comprise sites having meteorological patterns close to the meteorological patterns of the assessed target site.

8. The method according to claim 7, wherein the potential power generation sites having close meteorological patterns comprise sites having close latitudes and close geographic positions.

9. The method according to claim 8, wherein the step of receiving meteorological data and a operation parameter of the power generation system from at least one of potential power generation sites of an assessed target site via the computer system further comprises:
receiving recordings of historical meteorological data and a operation parameter of the power generation system from the first nearest site via the computer system, wherein the historical meteorological data comprise at least one qualitative weather description; and
storing weather rules associated with the qualitative weather descriptions and the weather-related factors via the computer system, and establishing a third-relationship model associated with the weather-related factor and the operation parameter of the power generation system of the potential power generation site according to the weather rules and recordings of the historical meteorological data and the historical operation parameter of the power generation system.

10. The method according to claim 1, wherein the weather factor comprises at least one of the strength of the ultraviolet radiation, the UV index, the atmospheric temperature/temperature in real feel, the cloud coverage, the wind speed and the wind direction.

11. The method according to claim 1, wherein at least one weather-related factor of the assessed target site is determined via the computer system according to the first-relationship model and the meteorological data from at least one of its potential power generation sites.

12. The method according to claim 11, wherein the step of receiving meteorological data and a operation parameter of the power generation system from at least one of potential power generation sites of an assessed target site via the computer system further comprises:
receiving recordings of the historical meteorological data and the historical meteorological data from the first nearest site via the computer system, wherein the historical meteorological data comprise at least one qualitative weather description; and
storing weather rules associated with the qualitative weather description and the weather-related factor via the computer system, and establishing a third-relationship model associated with the weather-related factor and the operation parameter of the power generation system of the potential power generation site according to the weather rules and recordings of the historical meteorological data and the historical operation parameter of the power generation system.
